(19) United States
(12) Patent Application Publication
(10) Pub. No.: US 2013/0318455 A1
(43) Pub. Date: Nov. 28, 2013

(54) Customizable software platform for x-ray imaging equipment

(71) Applicant: Vrindesh Shetty, Bohemia, NY (US)

(72) Inventor: Vrindesh Shetty, Bohemia, NY (US)

(73) Assignee: V. J. Technologies, Bohemia, NY (US)

(21) Appl. No.: 13/373,269

(22) Filed: Nov. 9, 2011

(51) Int. Cl. G06F 3/048

(52) U.S. Cl. CPC G06F 3/048
USPC 715/764

(57) ABSTRACT

The invention provides a software platform to customize the software programming needed to operate industrial X-ray imaging systems. Industrial X-ray systems require systems software for managing and controlling internal machine operation and exposing X-ray imaging and image processing capabilities. The various end users require different software programs to operate the equipment. The invention provides for a single software platform for developing a custom software program for the targeted end use. The customizing can be done without the need for software engineers. End-users can select from a stored list of software components that relate to the desired functional, workflow and graphical user interface requirements. Software components are provided that provide for the necessary linkages to create a customized application that is operable via a graphical user interface.

### FEDERAL SPONSORED RESEARCH

Not Applicable

### SEQUENCE LISTING OR PROGRAM

Not Applicable

### FIELD OF INVENTION

This invention relates to a software application that is customizable by end-users of X-ray imaging equipment. It enables the end-user to easily customize the software by Patent selecting the software components required to operate the equipment for the intended application.

### BACKGROUND OF THE INVENTION

Industrial X-ray machines exist at different levels of complexity and used in various applications such as automotive, aerospace, nuclear, food , oil and gas, defense, power generation and homeland security. One of the major concerns of the developers of X-ray imaging equipment is providing software that can meet the needs of the broad variety of end-users. Industrial X-ray machines vary from simple to the very complex, from manual to highly automated operations. As a result, systems software for such machines has wide ranging requirements in imaging, operational sequences and user-interfaces. Software in existing prior art is customized by the manufacturer of the equipment for the type of X-ray imaging machine as well as for the specialized end use the machine is designed for. Therefore, each machine sold for each application requires special software that requires significant software development resources by the manufacturer of the equipment. Industrial grade X-ray machines are constructed using imaging, mechanical, electrical, structural and computer hardware sub-assemblies and components. The requirements for X-ray functionality range from real-time detection similar to a video camera to linear array detection similar to a scanner or copier. Systems software needed for such machines provide for managing and controlling internal machine operations, for X-ray imaging and for image processing capabilities

Moreover, the end-user in most cases needs to employ the services of trained software engineers to operate the machine and to further customize the software for the intended application. End-users have distinct preferences on the workflow, the appearance of the user-interface and the operational needs of the equipment that can change for the different applications. Examples of applications range from a fully automated inspection system for high volume production of parts that need X-ray inspection requiring minimal user interactions to a specialized application for laboratory analysis that is operated by an expert user who requires ready access to many functions. End-users require different types of data to be captured for every part inspected. For example, pipe manufacturers need to store information on quality parameters such as thickness and other dimensional attributes whereas an automotive parts manufacturer may want to store information that is quite different such as Left-Hand v Right-Hand or All Wheel Drive v Front Wheel Drive. Prior Art requires that several distinct kinds of software exist, each suitable for a particular specification depending on the end-user requirements. This approach is expensive as there are an unlimited number of variations possible. Furthermore, new hardware such as improved X-ray detection equipment could be developed that will require new software to make them work. The greatest utility of the invention described in this specification is for X-ray imaging equipment, but the invention can be applied to other industrial equipment as well that depend on special customized software to control complex operations.

### BRIEF SUMMARY OF THE INVENTION

The invention described below provides a system and method that utilizes a common software platform that addresses the varied needs of the end-users within a single environment. The invention reduces the software development efforts for the various applications. The invention is a systems software platform that consists of a collection of reusable software components, an environment for assembling such components, a control flow structure that enables custom sequencing and interaction of components, provides for the ability to configure the software workflow to application requirements, provides for customization of user-interface and provides for an extensible platform for adding or enhancing components, functions and features. According to the various aspects of the invention, the software platform provided is used to customize needed software components by loading these components into a tree data base structure for viewing and editing the Solution.

In the preferred embodiment the software components are advanced versions of software components like ActivX™ and Component Object Models (COM). The Solution is stored in an Extensible Markup language (XML) file. The customized Solution enables acquisition, processing, analysis, viewing, archiving, decision making and reviewing that are needed to operate X-ray imaging equipment. Thereby the invention enables the development of customized X-ray systems software for a wide range of applications of varied complexities with minimal software development, minimal resources expenditure, minimal effort, minimal time and at much reduced costs. The invention enables customized software construction by a field or applications engineer rather than by a specialized software developer. Any changes to workflow logic do not require expensive software engineering time. Service personnel and end-users can implement such changes themselves with minimum training. The invention facilitates on-site operational workflow and user-interface implementation as needed by the end-user. It allows for authentication of the operator as various levels of authority as set by the end-user.

Newer X-ray sources, detectors and image processing algorithms that are developed are accommodated into the common framework of the invention. The invention allows new requirements or enhanced features and functionality to be incorporated into existing and new machines without any significant operational disruption. For example, a new type of detector can replace an older type at the end-user and the new detector will work seamlessly in the old software platform.

The present invention and its advantages over the prior art of software systems used to operate X-ray machines will become apparent upon reading the following detailed description and the appended claims with reference to the drawings that are part of the specification of the invention. In the drawings and specification “software component” and component are used interchangeably.

### BRIEF DESCRIPTION OF THE DRAWINGS

FIG. 1 shows an exemplary flow diagram of the method used to select the individual software components in relationship to the workflow requirements and the user interface requirements to arrive at the customized solution tree for the intended application.

FIG. 2 shows an exemplary block diagram of the constituent components of a macro.

FIG. 3 shows an exemplary flow diagram of the viewing and editing components for a particular application.

FIG. 4 is an exemplary flow diagram for saving a solution tree for an application.

FIG. 5 is an exemplary block diagram of the software components.

FIG. 6 shows an exemplary flow diagram showing the addition of a software solution or folder to the solution tree.

FIG. 7 shows an exemplary flow diagram of an user defined macro sequence.

FIG. 8 shows an exemplary block diagram of software solution components needed for a particular application.

FIG. 9 shows an exemplary flow diagram of a macro specification for a particular application.

### DETAILED DESCRIPTION OF THE INVENTION

According to the various aspects of the invention a software platform is provided that may be easily customized to meet the unique needs of end users of X-ray imaging machines without custom programming The end user uses the software platform to create a custom application for his use. The software platform contains defined components that are selected and are incorporated into the final custom application (Solution). The Solution provides for basic logical constructs and component interactions using software that work to provide the Solution without programming. The end-user is not required to be a software engineer.

A component is an executable entity that encapsulates a function or a set of functions. In the preferred embodiment these components are similar to, but are advancements on software components that have grown out of ActiveX™ and Component Object Model (COM) objects. These enhancements are not the subject of this invention. For example, the movie making function exposes parameters that are applicable to movie making like the frame rate and the file name. When executed, it outputs a movie file in accordance with the parameters set

Every component in the invention has a common interface that lets it be instantiated when the Solution starts up and executed when the Solution is run. After the components are loaded in the Solution, the properties of the component can be viewed and configured. This is done through smart draw down lists and parameter value controls that can automatically scan the entire Solution and propagate a list with all the components that are of the correct type to be linked to the selected component. After they are linked the components have the capability of dynamically working together. Components are serialized to an Extensible markup Language (XML) format that lets them be reconstituted identically every time the particular Solution is started up.

Examples of components used in the invention are: a) Database: that is used to map variables to the fields in a relational database such as SQL™ Server; b) Macros: that are used for building custom macros that can be run by the end-user to perform repetitive tasks. Macros are comprised of other components arranged in a logical order; c) Image-Boxes: that handle the core imaging for the software platform including storage and manipulation algorithms; d) Image-Devices: that provide base classes to interface to acquisition devices and cameras; e) Image-Display: is used to display and manipulate images. It also displays toolbars, annotations, statistical information, measurement tools and access to macros and filters; f) Image-Filters: contain image processing filters that are used to enhance images.

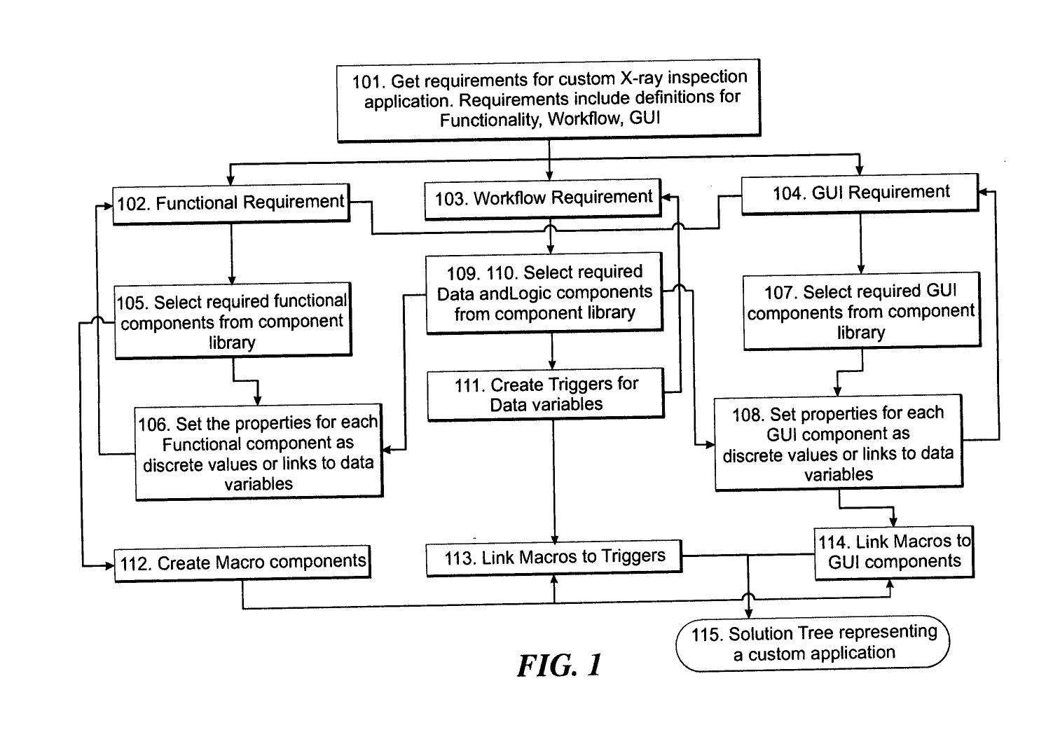

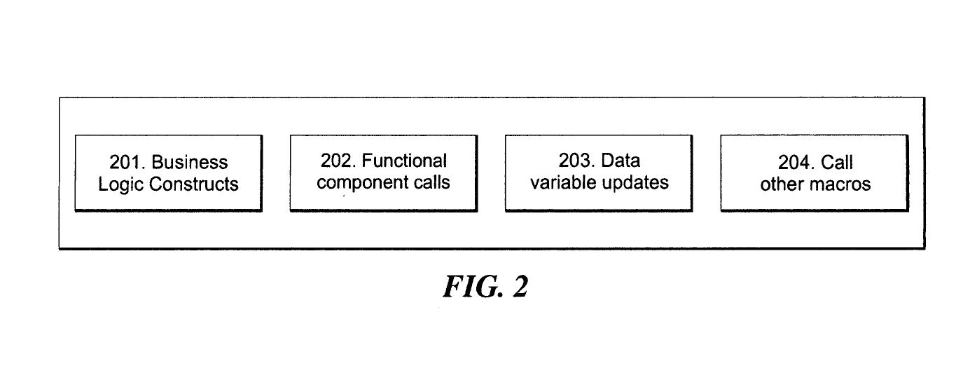

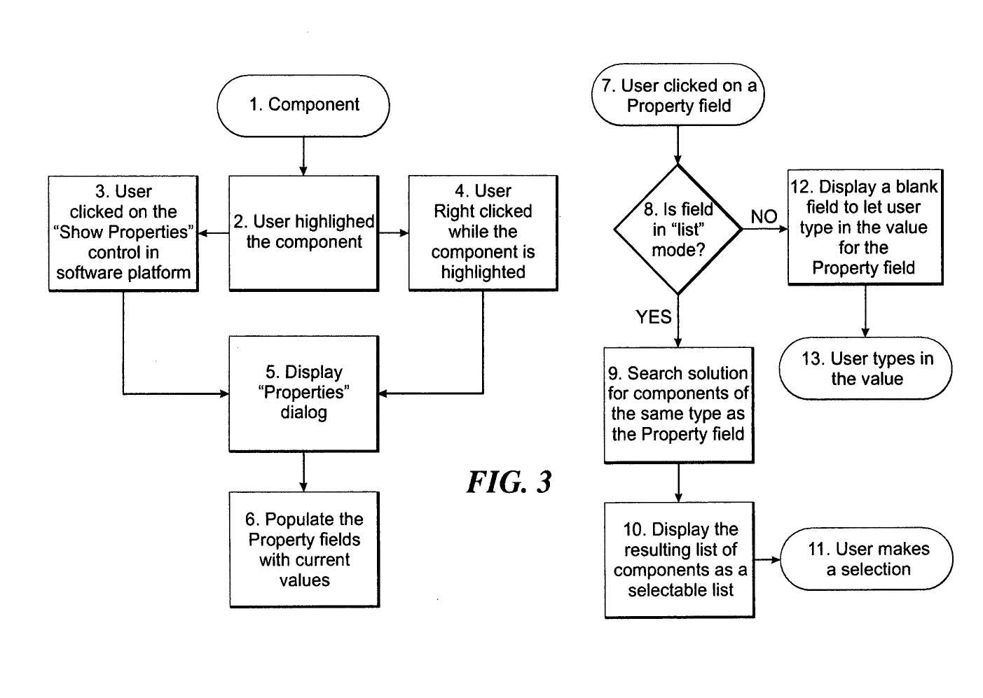

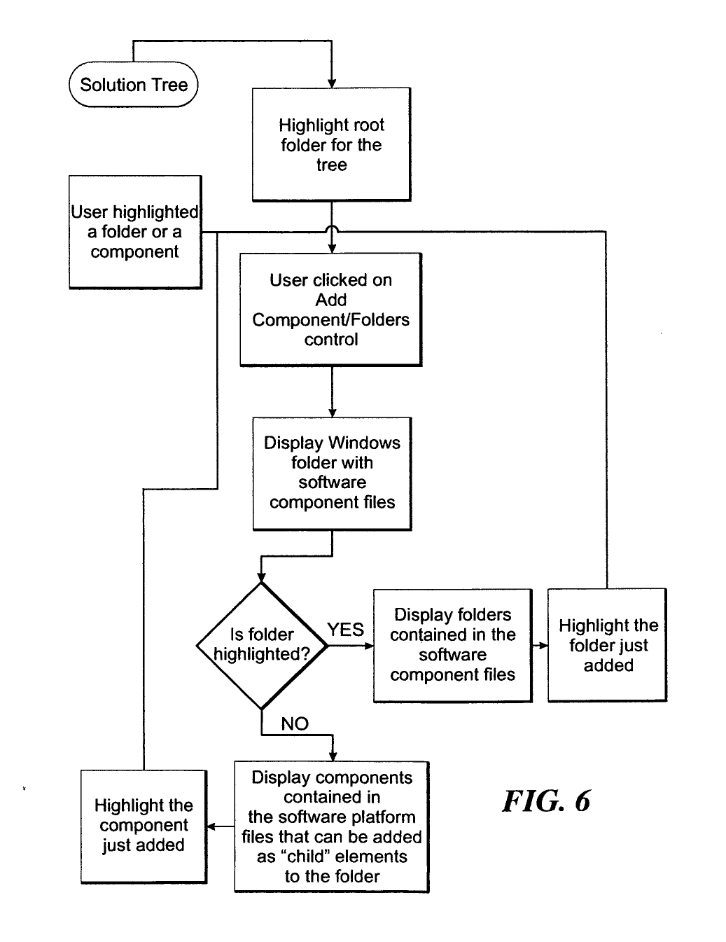

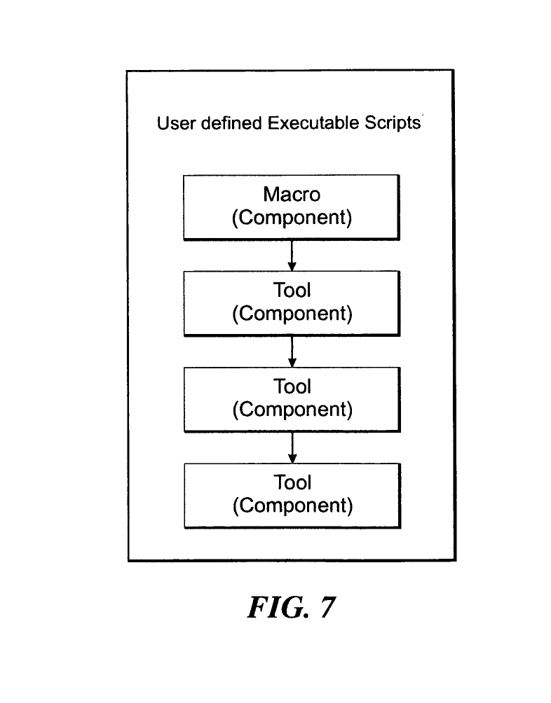

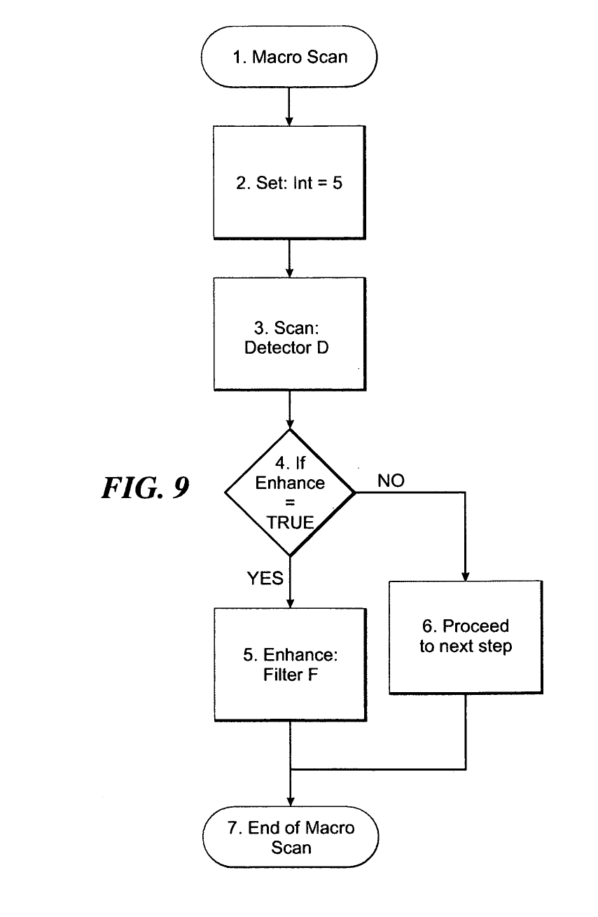

FIG. 1 shows an exemplary flow diagram of the system and method used to create the Solution for the end user. The end user selects the individual software components in relationship to the functional, workflow and the Graphical User Interface (GUI) requirements to arrive at the customized application (Solution) for the intended application. In the preferred embodiment the Solution is presented in the form of a tree display. The process stars with the selection of the user requirements for the custom application (101). The functional requirements (102) include the feature set required for inspection. Any external devices that the system platform is required to interact with such as X-ray detectors , Programmable logic Controllers (PLC) are specified in this category of requirements. Workflow requirements (103) include the sequence of operations desired by the end-user and the rules of operation or the business logic. GUI requirements include the desired look and appearance of the customized application such as the placement of user interface control, and the language and text for the control labels. The end-user has a selection device such as a pointer to be able to select, view and edit the various components needed for the application. An exemplary flow diagram of the process used to view and edit components is shown in FIG. 3. Based on the functional requirements (102) that have been identified, components that encapsulate these requirements are selected from the component library. The component library exists as a set of files. A typical component related to the functional requirements would be an X-ray detector. Each functional component has a set of properties that is used to configure the component as per the requirements (106). The property values are set by either linking them to data variables or assigning static values to them. Based on the identified GUI requirements (104), components that encapsulate these requirements, such as for example (an image display window) are selected from the component library (107). The properties of the GUI components are set as per the requirements. GUI control behavior can be made to reflect the state of the system by dynamically linking display properties to data variables. As a result of the linkage the values of the variables decide one or more aspects of the GUI control. As an example a Boolean variable can be used to display or hide a particular control (108). The use of Boolean variables is shown in FIGS. 6, 7 & 8. Data components such as Integers, Booleans, and Structures serve as controllers for the workflow and the GUI status of the custom application (108). A number of components (such as “Copy”) exist in the software platform to handle data manipulation. Logic components such as ‘If Then Else“, “while loop” use the data components in the component library as shown in (109) to control the workflow (110). Triggers are used to provide event based control flow to the custom application. The events are generated by any change in the data component associated with the trigger (111). The components of a macro are shown in FIG. 2. Macros are made of one or more functional, data and logical components, sequenced in a logical order to perform a desired function. A macro can invoke other macros in its sequence (112). Flow chart example of a macro is shown in FIG. 9. An example of a macro creation is shown in FIG. 7. Macros are associated with the triggers described in (111) such that the macro will be invoked in response to a change in value of the data variable associated with the trigger (113). Macros are also associated with certain GUI controls such as “button” so that an end-user indicating the ‘button” will cause the macro to be invoked. The flow charted process shown in FIG. 1 results in a custom application being developed for the X-ray imaging system. The custom application file (Solution) contains a listing of all of the functional, workflow, GUI and macro components that represent the X-ray imaging application in its entirety. The preferred embodiment saves this in an Extensible Makeup Language (XML) file.

FIG. 2 is an exemplary block diagram of the constituent components of a macro. Business Logic Constructs (201) provide conditional execution capability. An example is the “If Then” software component. For example this component has a property that can be linked to a Boolean data component. Based on the (True/False) value of the Boolean data component, the “If Then” component will either execute or ignore depending on the True/False value of the Boolean data component. Functional Component Calls (202) provide the desired actions of the macro. An example is the “X-ray Detector” component. When executed, this component makes a scan and stores the scanned image into the property that can be linked to an Image-Box component. Data variable Updates (203) provide the data variables that can be used by the Business Logic Constructs and the Functional Component Calls. Call Other Macros (204) provides the “Run Macro” component that has a property that can be linked to another macro. When executed the reference macro is invoked.

FIG. 3 is an exemplary flow diagram of the viewing and editing functions described in paragraph 0019. A person skilled in the art is easily able to understand through the flow diagram how the software to view and edit components has been developed.

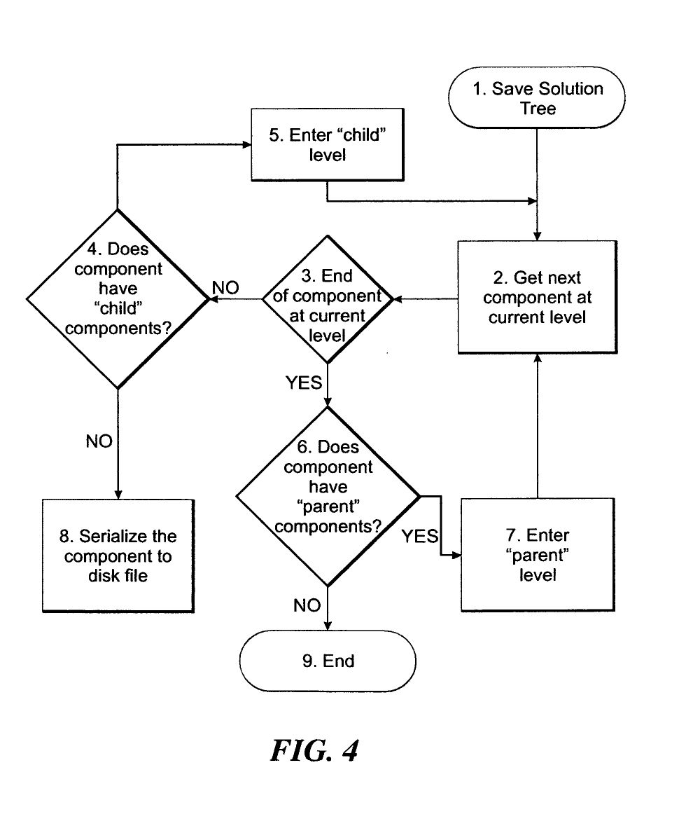

FIG. 4 is an exemplary flow diagram for the process used to save a customized application (Solution) describe in paragraph 0019. A person skilled in the art is easily able to understand how the software to save the Solution has been developed. The Solution in the preferred embodiment is archived as an XML file. This flow chart describes the procedure for traversing the solution tree and archiving all the constituent components.

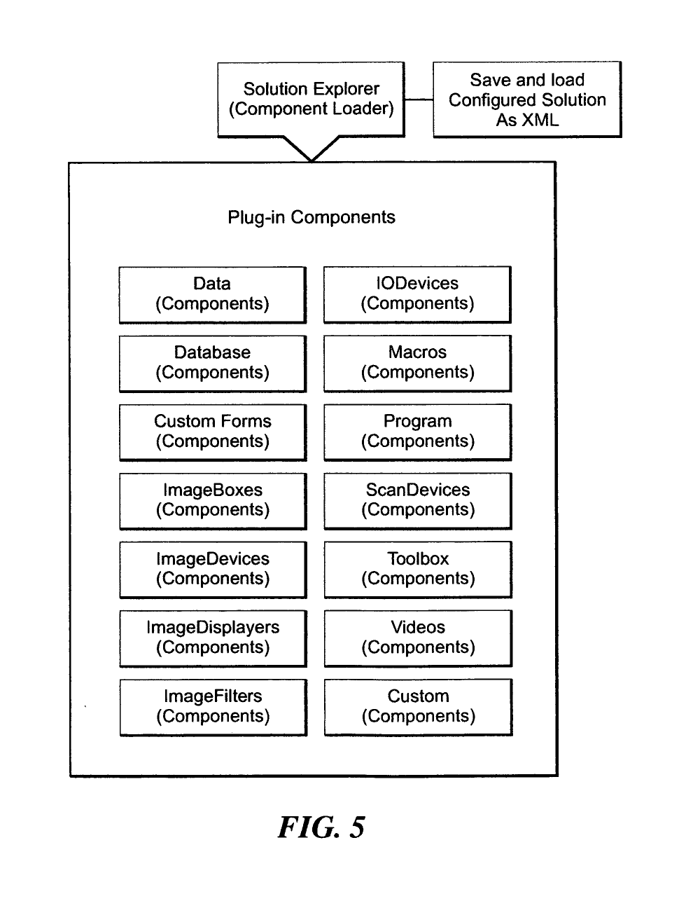

FIG. 5 is an exemplary block diagram of the various components that are used in the software platform. These include Data, Database, Custom Forms, Image-Boxes, Image-Devices, Image-Displayers, Image-Filters, Input and Output (10) devices, macros, Programs, Scan-Devices, Toolbox, Videos, and custom components described elsewhere in the Specification.

FIG. 6 is an exemplary flow diagram of the process used to add a component or a folder to a custom application (Solution) described in paragraph 0019. A person skilled in the art is easily able to understand how the software to add a component to the Solution is accomplished. The base software program provides the ability to load software components into a tree data base structure for viewing and editing the Solution. The tree structure contains folders, wherein each folder is a container for “like” components. For example, all X-ray detectors are grouped under the folder Image-Devices and all Integer Data variables are grouped under the folder structure Data/Integer. The software platform provides the ability to add, delete and rename components through the GUI. In order to add a component, the end-user highlights a folder from the tree structure using a selection device such as a mouse and then clicks on a control that adds components. This opens a Windows™ folder containing the software platform's component files. Each file is an assembly file that contains one or more software components. Upon choosing a file, a dialog box opens with a list of software components contained in the file that can be added to the highlighted folder. In order to delete a component, the end-user highlights the component by clicking on it and then clicks on a control that allows him to delete the component. The same process can be used to re-name a component.

The preferred embodiment displays the customized application (Solution) in the form of a solution tree. A typical solution contains one or more of the following components to enable the functionality specified by the end-user. 1. Data variables such as a) integer, date/time, double and Boolean variables to hold program data and logic; b) string variables to hold messages or user input and c) structures to hold a collection of primitive variables described in (a). 2. Image displays that provide for a customizable user interface to images and toolbar functionality. 3. Image-boxes that hold image buffers. 4. Macros that are min-solutions that run in response to a linked button or to data triggers. 5. Program logic such as a) If-Then constructs and b) process constructs that are mini-solutions that run in a separate thread. 6. User-interface elements comprising a) tool bar buttons that run macros when selected and b) tool bar labels that display contents of the variables.

FIG. 7 is a flow chart of a macro used in the software platform. The macro consists of executable components arranged in a logical order. When the macro is invoked, the components contained in the macro are sequentially executed. Logic components such as If-Then-Else and Loop provide the ability to conditionally execute particular components of the macro. Macros are thread safe and unlimited macros can be running at the same time on different threads or CPU cores.

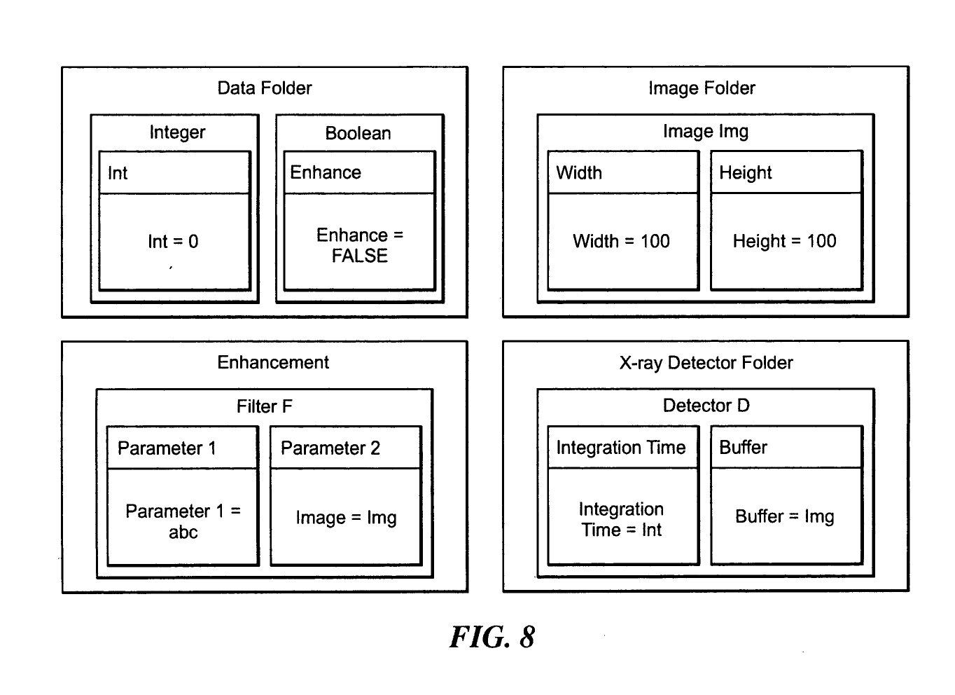

FIG. 8 is a block diagram for an exemplary creation of a macro. This macro is required to scan an image and conditionally apply a filter to the scanned image. This task can be encapsulated via a macro component along with the following components. 1. Integer Data Component: Int. 2. Boolean Data Component: Enhance.3. Image Component: Img. 4.Enhancement Functional Component: Filter F. 5. X-ray Detector Functional Component: Detector D.

The flow chart in FIG. 9 shows the process of how the exemplary macro works. 1. Start the macro. 2. Use a logic component to set the variable (Int) to the value 5. 3. Perform a scan with the detector component Detector (D). Since the value of the integration time, a parameter of D is linked to the variable (Int), the Detector D will scan at the integration time of 5. The scanned image will be stored in the variable (Img). 4. Check the value of the variable (Enhance). If it is (TRUE) then invoke the functional component Filter (F). Since the value of the image, a parameter of (F) is linked to the variable Img, the component acts on Img. 6. If it is (FALSE), proceed to the next step without invoking the functional component Filter (F). 7. End of macro.

The above disclosure shows an invention of a software platform to develop a custom application for an X-ray imaging system, but it can be recognized that this invention can be used to develop applications for other industrial equipment that are utilized in complex ways for multiple applications.

What is claimed is:

1. A system for establishing a custom application for X-ray imaging equipment comprising:
a database of software components in a library each component being capable of selection;
software means for an user to enter requirements for the application;
software means for linking the components to the requirements;
a graphical user interface to permit operating an X-ray imaging system.

2. The system of claim 1 wherein the database is a relational data base.

3. The system of claim 1 wherein the components are executable entities that encapsulate a function or set of functions.

4. The system of claim 1 wherein the user selected requirements are functional, workflow and user interface requirements.

5. The system of claim 4 wherein the functional requirements include external features required for the X-ray imaging system.

6. The system of claim 5 wherein the external features include X-ray detectors, X-ray sources and programmable logic controllers.

7. The system of claim 4 wherein the workflow requirements include a sequence of operations and logic desired by the user.

8. The system of claim 4 wherein the graphical user interface requirements include the appearance of the interface and placement of control labels.

9. The system of claim 1 wherein the software means include data components, logic components, triggers and macros.

10. The system of claim 9 wherein the data components serve as controllers for the workflow and the graphical user interface status of the custom application.

11. The system of claim 9 wherein the logic components use the data components to control the workflow requirements set by the user.

12. The system of claim 9 wherein events are generated by changes in the data components associated with the triggers.

13. The system of claim 12 wherein the triggers provide event based control for the custom application.

14. The system of claim 9 wherein the macros are made of a combination of one or more of the data and logic components sequenced in a logical order to perform a desired task.

15. The system of claim 14 wherein the macros can invoke other macros in its sequence.

16. The system of claim 9 wherein the macros are invoked in a response to a change in the value of a data variable associated with the trigger.

17. The system of claim 9 wherein the macros are linked to the graphical user interface control buttons that invoke the required macro on contact.

18. A computerized method for developing a custom application for an X-ray imaging system comprising:
maintaining a database of software components in a library;
providing software means to the user to enter requirements for the application;
providing software means for selecting the components related to the requirements; and
providing a graphical user interface to permit operating the X-ray imaging system.

19. In a computer system having a graphical user interface including a display and selection device, a method of providing and selecting from a library of software components on the display, the method comprising:
retrieving a set of entries for the application, each entry representing a software component;
displaying the set of the selected components on the display;
receiving a component entry selection signal indicative of a selection device pointed at the selected entry from the set of entries; in response to the signal performing a search of the database for related components to the selected component; and arriving at a custom application of the selected components to operate an X-ray inspection equipment.
